(19) United States
(12) Patent Application Publication
(10) Pub. No.: US 2016/0045838 A1
(43) Pub. Date: Feb. 18, 2016

(54) OLFACTORY DEVICE

(71) Applicant: GIVAUDAN SA, Vernier (CH)

(72) Inventors: Matthew Charles BURLAND, Cincinnati, OH (US); Joseph Andrew KAISER, Alexandria, KY (US)

(21) Appl. No.: 14/779,209

(22) PCT Filed: Mar. 31, 2014
(86) PCT No.: PCT/EP2014/056420

§ 371 Date: Sep. 22, 2015

Related U.S. Application Data
(60) Provisional application No. 61/806,460, filed on Mar. 29, 2013.

(51) Int. Cl. A63J 25/00; B05B 7/24; B05B 1/00; G09B 5/06

(52) U.S. Cl. CPC A63J 25/00; G09B 5/06; B05B 7/2489; B05B 1/005

(57) ABSTRACT

An aroma substance delivery device adapted to deliver an aroma substance exclusively to the nasal cavities of an individual, comprising the following elements:
(i) a source of carrier gas flow;
(ii) regulating means which receives the carrier gas flow and regulates its passage through a plurality of channels;
(iii) downstream of the regulating means a plurality of aroma substance-containing cartridges, one being associated with each channel, and
(iv) disseminating means located in close proximity to the cartridges and adapted to deliver the individual aroma substances from the cartridges to nasal cavities by means of a conduit;
   there being positioned in each channel on the upstream side and in close proximity to the origin of the channel a flow restrictor, the flow restrictor being configured such that the pressure drop across the flow restrictor is higher than the pressure drop across the rest of the device. The device is particularly useful as an element in conjunction with an audiovisual display, to provide a complete sensory experience.

This disclosure relates to a method of disseminating vapour-phase substances to the nasal cavities of an individual user as part of a media presentation.

It has been suggested that aroma substances, that is, substances that are either in vapour form or can easily be converted to vapour form and in which form provide a desired odour, may be used in media presentations, for example, in cinemas and theatres, to enhance the verisimilitude of the experience. A number of such systems have been suggested and even made and operated, but all suffer from the drawbacks that, in an auditorium, even a small one, large volumes of aroma substances are required, and substantial ventilation systems are required both to blow the substances into the auditorium and to extract them in sufficiently short time for the next substances effectively to be used. In addition, achieving a uniform effect for an entire audience, even quite a small one, is a daunting technical challenge.

A different approach was taken by U.S. Pat. No. 6,371,165, in which vapour-phase substances were supplied to the nasal cavities of an individual user via a conduit. This allowed not only for the use of small quantities of substance, but also of rapid changes in substance to match the viewed programme. This versatility allowed such devices to be used not only in auditoriums, but also in domestic settings, for example, in conjunction with DVD players and computer downloads. The system may be computer-controlled and may utilize sophisticated algorithms to deliver its mixtures.

Such a device is not without its problems. For example, while much smaller than the prior devices, it is still of substantial size. In addition, there is no mention of the length of the tubing that takes the scent from the device to the nasal passages. This is an important factor; if a conduit is too long, there is often observed a fractionation effect, in which various components of the desired aroma move at different rates and reach the nasal cavity at different times, thus spoiling a carefully-calculated desired olfactory effect.

It has now been found that these problems can be substantially and even completely overcome by means of a device that allows a hitherto unachievable miniaturisation, thus allowing the manufacture of devices that are easily incorporated into seats, or even made wearable. The disclosure therefore provides an aroma substance delivery device adapted to deliver an aroma substance exclusively to the nasal cavities of an individual, comprising the following elements:
(i) a source of carrier gas flow;
(ii) regulating means which receives the carrier gas flow and regulates its passage through a plurality of channels;
(iii) downstream of the regulating means a plurality of aroma substance-containing cartridges, one being associated with each channel, and
(iv) disseminating means located in close proximity to the cartridges and adapted to deliver the individual aroma substances from the cartridges to nasal cavities by means of a conduit; there being positioned in each channel on the upstream side and in close proximity to the origin of the channel a flow restrictor, the flow restrictor being configured such that the pressure drop across the flow restrictor is higher than the pressure drop across the rest of the device.

The source of carrier gas may be any suitable source of gas. For example, the carrier gas may be air, and the source may be a compressor. Alternatively, the source may be a pressurised cylinder of gas.

The gas flow is conveyed to a regulating means. This means is typically a device that comprises a plurality of channels adapted to convey the gas to cartridges containing aroma substance, one cartridge per channel. Thus, by opening and closing channels and maintaining these openings and closings for predetermined times, the regulating means can determine which aroma substances and how much thereof are conveyed and when, and thus alter the nature of the aroma perceived by a user. Devices that can fulfil this function are well known in the field of orthonasal testing, for example the MiniVAS™ device of Givaudan. The operation of the regulating means may be remote, for example, by computer either wired to the regulating device or operating it wirelessly. Thus, the operation of the individual channels may be programmed, such that particular types and quantities of aroma substances may be delivered in synchronisation with an audio-visual event, such as a film or slide show. This aspect is further described hereinunder.

In a particular embodiment, such a regulating means is capable of regulating the carrier gas flow, suitably charged with aroma substances, to a plurality of disseminating means. Thus, such a means may, for example, provide identical aroma substances to a plurality of users simultaneously, for example, patrons in a cinema.

The cartridges of aroma substance from which the desired aroma is created may be any suitable cartridge capable of containing the desired aroma substances and releasing them when impinged upon by a carrier gas. One particular type is a cartridge comprising a reservoir containing an aroma substance and being provided with inlet and outlet channels to permit ingress of carrier gas into the reservoir and egress of aroma substance-containing carrier gas from the reservoir, the channels being defined by capillaries having internal diameter and length dimensions sufficient to act as closure means to prevent, or substantially prevent, leakage of aroma substance from the reservoir into a head space external of the cartridge when carrier gas flow is interrupted. Such a cartridge is described in European Patent 1523340. It has the advantages that it can be small and very slim (about credit card-sized) and that it need no valve arrangements, merely a supply of carrier gas to entrain the substance from the cartridge and means of directing and regulating this. Such cartridges are easily replaced when empty.

The aroma substances that are entrained by the gas flow from the cartridges are conveyed by the carrier to a disseminating means via a conduit. The nature of the disseminating means may be any disseminating means capable of delivering a vapour-phase substance to the nasal cavities of an individual. For example, it may be a small nose piece able to be worn, or it may be an open tube placed near the nasal cavities. Typical examples of suitable disseminating means are those described in the abovementioned U.S. Pat. No. 6,371,165 and EP 1523340. Alternatively, it may be a tube mounted on a seat and capable of adjustment to be near the nose of a seat occupant. Many possible variants will occur to the skilled person. The various aroma substances may be blended prior to entering a single conduit, or each aroma substance may arrive at the disseminating means via individual conduits.

The aroma substance-containing cartridges are placed in close proximity to the disseminating means. By “close proximity” is meant that the distance between cartridge and disseminating means should be kept to a minimum. What this minimum is will be determined by the specific nature of the device and its location, but the skilled person will readily be able to determine a suitable solution in any particular case. For example, if the disseminating means is mounted on a flexible “gooseneck”-type fitting of the type frequently used for microphones), the cartridges should be as close as practicable to the mounting end of the gooseneck, for example, in a compartment of an audience seat headrest.

A further feature of the device is the presence of flow restrictors upstream of the cartridges with respect to the gas flow and in close proximity to the origin of the channel. By “origin of the channel” is meant that point in the apparatus where the channel becomes an individual channel. In a typical arrangement, this will involve a manifold that receives the gas flow, and from which emerge the desired plurality of channels, one per cartridge. In such a case, the flow restrictors should be placed as close to the manifold as possible, and may form part of the manifold.

Suitable flow restrictors are well known to the art, and are commercially available from, for example, Universal Microsystems and Mott Corp. The type selected is such that the pressure drop across the flow restrictor is greater than that across the rest of the device as a whole. In such a configuration, they are rate-determining, and they do away with the need for complicated and expensive mass-flow controllers.

As previously mentioned, the device may additionally comprise control means that control its entire operation, including the selection and quantity of aroma substance at any desired time by means of operation of the regulating device. Control means capable of such operations are well known to the art, and are available as off-the-shelf hardware, or can be made or modified by a skilled person. The software required for such operation and its generation of the necessary operational signals are also well known to the art and a skilled programmer can easily provide suitable programming for any use.

The control means may be located in any convenient location, for example, within individual cinema seats, or in close proximity to a group of seats, or it may be in a single central location, giving instructions to a plurality of regulating devices by wire or wireless means. It may be manually operated, or it may be a completely automated unit into which all necessary inputs are programmed and which generates all the necessary inputs at the appropriate times and communicates them to the regulating means.

The device is particularly useful in conjunction with audiovisual presentations for entertainment and education, for example, movies, slide shows, theatrical presentations, and the like. It is possible to use the device in live presentations, such as plays, operas and ballets. In such a case, it is generally preferred to operate the device manually from a central location. However, in a particular embodiment, in which visual projection of images is involved, a suitably-programmed central computer can coordinate all aspects of a presentation, coordinating visual, audio and olfactory elements, to provide a complete and perfectly-timed sensory experience.

The device may be operated centrally in a theatre, such that all patrons may receive the same vapour-phase substance at the same, appropriate time. As hereinabove described, this may be done manually, or it may be completely automatic, programmed to react to signals that may be transmitted by cable or wirelessly. In a domestic situation, for example, with a DVD player, the appropriate signals may be encoded on the DVD, and these then communicated to the device by any suitable means, such that the appropriate vapour-phase substance is released at the appropriate time and in the appropriate quantity. In the case of a television programme or a digital download from a computer, the appropriate signals may be encoded according to a predetermined standard format.

The device hereinabove described is very useful in conjunction with entertainment venues such as cinemas, theatres, pubic lectures and the like. It may also be used in domestic situations, in conjunction with television, DVD players and digital download material. The disclosure therefore provides means for the provision of individual olfactory sensation as part of an audiovisual educational or entertainment presentation, comprising a device as hereinabove described.

There is also provided a method of providing to an individual an olfactory sensation corresponding to a simultaneously-perceived visual and/or auditory sensation, comprising supplying to the nasal passages of the individual an aroma substance, the aroma substance being supplied by operation of a device as hereinabove described.

There is further provided a complete sensory audio/video/olfactory educational or entertainment experience in which the senses of sight, hearing and smell are simultaneously stimulated in a coordinated manner, comprising the provision of audio/visual apparatus having coordinated visual and aural elements, plus additional olfactory elements coordinated with the visual and/or aural elements, the coordinated olfactory elements being provided by an aroma substance delivery device as hereinabove described.

The disclosure is further described with reference to the accompanying drawings, which depict particular embodiments of the device, and which are not meant to be in any way limiting.

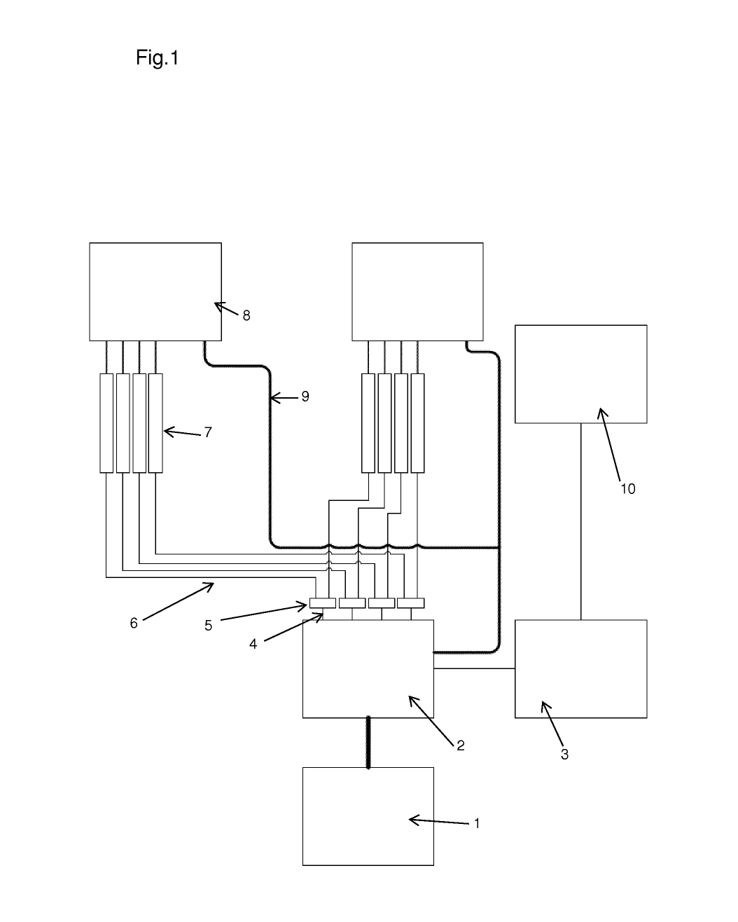

FIG. 1 is a schematic representation of a device as hereinabove described, for use with an audiovisual system with multiple audience places.

For simplicity of illustration, the device of FIG. 1 is depicted as having only two disseminating means and 4 aroma substance cartridges each. In reality, the device would have as many disseminating means as there are audience places and as many cartridges as are needed for the desired range of olfactory sensations in the audiovisual display.

An air compressor 1 is attached to a regulating means 2. The regulating means is a MiniVAS™ device (ex Givaudan). This regulating means contains regulating valves controlling the passage of air from the compressor to a plurality of primary channels 4, one per aroma substance. The regulating means is controlled by a computer 3, which is programmed with the information as to which aroma substances are to be released in which proportions at which time and for which time period to provide the desired olfactory sensation.

The primary channels 4 extend from the regulating means 2 to a series of manifolds 5. From these manifolds extend a series of secondary channels 6, one secondary channel per audience place. Within each secondary channel 6 at the point where it exits from the manifold 5 is placed a flow restrictor, configured such that the pressure drop across the flow restrictor is higher than the pressure drop across the rest of the device.

Each secondary channel 6 leads to an aroma substance cartridge 7, these being of the type described in European Patent 1523340, and each containing an individual aroma substance. From the cartridges 7, the secondary channels extend further to a disseminating means 8, in this case an individual nose-piece, placed such that the distance between the cartridges and the nose-piece is small. Each nose-piece is additionally equipped with a further air channel 9, extending independently from the regulating means 2, and also under the control of the computer 3. This is adapted to communicate directly to the nose-piece 8 additional air, for the purposes of suitable dilution or for clearing an odour from the nose-piece in preparation for the next odour.

In practice, all instructions are programmed into the computer 3, which also controls an audiovisual projector 10. As the display continues, the computer activates the regulating means 2 to deliver, in conjunction with the cartridges 7, at the appropriate time and in the appropriate quantity and duration, olfactory sensations to accord with what the individual wearers are observing, courtesy of the projector.

1. An aroma substance delivery device adapted to deliver an aroma substance exclusively to the nasal cavities of an individual, comprising the following elements:
(i) a source of carrier gas flow;
(ii) regulating means which receives the carrier gas flow and regulates its passage through a plurality of channels;
(iii) downstream of the regulating means a plurality of aroma substance-containing cartridges, one being associated with each channel, and
(iv) disseminating means located in close proximity to the cartridges and adapted to deliver the individual aroma substances from the cartridges to nasal cavities by means of a conduit;
there being positioned in each channel on the upstream side and in close proximity to the origin of the channel a flow restrictor, the flow restrictor being configured such that the pressure drop across the flow restrictor is higher than the pressure drop across the rest of the device.

2. The delivery device according to claim 1, in which each aroma substance-containing cartridge comprises a reservoir containing an aroma substance and inlet and outlet channels to permit ingress of carrier gas into the reservoir and egress of aroma substance-containing carrier gas from the reservoir, the channels being defined by capillaries having internal diameter and length dimensions sufficient to act as closure means to prevent, or substantially prevent, leakage of aroma substance from the reservoir into a head space external of the cartridge when carrier gas flow is interrupted.

3. Means for the provision of individual olfactory sensation as part of an audiovisual educational or entertainment presentation, comprising the device according to claim 1.

4. A method of providing to an individual an olfactory sensation corresponding to a simultaneously-perceived visual and/or auditory sensation, comprising supplying to the nasal passages of the individual an aroma substance, the aroma substance being supplied by operation of a device according to claim 1.

5. A complete sensory audio/video/olfactory educational or entertainment experience in which the senses of sight, hearing and smell are simultaneously stimulated in a coordinated manner, comprising the provision of audio/visual apparatus having coordinated visual and aural elements, plus additional olfactory elements coordinated with the visual and/or aural elements, the coordinated olfactory elements being provided by an aroma substance delivery device according to claim 1.

6. A method for the provision of individual olfactory sensation as part of an audiovisual educational or entertainment presentation, comprising providing an aroma substance with the device according to claim 1.

7. A method of providing a complete sensory audio/video/olfactory educational or entertainment experience in which the senses of sight, hearing and smell are simultaneously stimulated in a coordinated manner, comprising providing audio/visual apparatus having coordinated visual and aural elements, and providing additional olfactory elements coordinated with the visual and/or aural elements, the coordinated olfactory elements being provided by the aroma substance delivery device according to claim 1.

8. A system for delivering an aroma substance to one or more users comprising:
(i) the aroma substance delivery device according to claim 1;
(ii) an audiovisual output means; and
(iii) a controller for controlling said regulating means of said aroma substance delivery device and said audiovisual output means.

9. A system for delivering an aroma substance to one or more users comprising:
(i) at least one user location;
(ii) the aroma substance delivery device according to claim 1; and
(iii) a controller for controlling said regulating means of said aroma substance delivery device.

10. A system for delivering an aroma substance to one or more users comprising:
(i) at least one user location;
(ii) the aroma substance delivery device according to claim 1;
(iii) an audiovisual output means; and
(iv) a controller for controlling said regulating means of said aroma substance delivery device and said audiovisual output means.
